(19) United States
(12) Patent Application Publication
(10) Pub. No.: US 2020/0337501 A1
(43) Pub. Date: Oct. 29, 2020

(54) DOMESTIC FOOD PROCESSOR

(71) Applicant: Vorwerk & Co. Interholding GmbH, Wuppertal (DE)

(72) Inventor: Matthias Stein, Mülheim an der Rhur (DE)

(21) Appl. No.: 16/842,206

(22) Filed: Apr. 7, 2020

(30) Foreign Application Priority Data
Apr. 24, 2019 (EP) 19170795.9

(51) Int. Cl. A47J 43/046; A47J 44/00

(52) U.S. Cl. CPC A47J 43/046; A47J 44/00

(57) ABSTRACT

The present disclosure relates to a domestic food processor with a plurality of electrically operable functional components for preparing a food in a pot. A control unit of the domestic food processor can access a recipe and can be caused by a recipe step of the recipe to operate one of the functional components in a manner defined by the recipe step. The recipe is configured such that the recipe defines at least one start condition for each of a plurality of recipe steps. The control unit is configured such that, depending on the start conditions of the recipe steps, the control unit can set at least one next recipe step at the latest at the end of a preceding recipe step. The present disclosure further relates to a process and computer program products. It is thus possible to prepare a food semi-automatically in a shorter time.

### FIELD OF THE DISCLOSURE

The present disclosure relates to a domestic food processor with a plurality of electrically operable functional components for preparing a food in a pot. A control unit of the domestic food processor can access a recipe and be caused by a recipe step of the recipe to operate one of the functional components in a manner defined by the recipe step. The disclosure further relates to a process and computer program products.

### BACKGROUND

Domestic food processors such as the Thermomix®, which can access digital recipes for the semi-automated preparation of a food, are known. To prepare a food, a user successively works his way through the recipe steps in the sequence given by the recipe, just like cooking according to a recipe in a cookbook.

It is the task of the present disclosure to provide a further developed domestic food processor.

### SUMMARY

A domestic food processor with a plurality of electrically operable functional components for preparing a food in a pot is provided in this disclosure. A control unit of the domestic food processor can access a recipe and be caused by a recipe step of the recipe to operate one of the functional components in a manner defined by the recipe step. The recipe is configured such that the recipe defines at least one start condition for each of a plurality of recipe steps. The control unit is configured such that, depending on the start conditions of the recipe steps, the control unit can set at least one next recipe step at the latest at the end of a preceding recipe step. It is thus possible to prepare a food semi-automatically in a short amount of time.

The recipe thus leaves the sequence of the recipe steps open, i.e. the recipe does not define the sequence of the recipe steps but only at least one start condition of a recipe step. The sequence of the recipe steps is set by the control unit on the basis of at least the start conditions of the recipe steps. The sequence of the recipe steps is therefore defined by the recipe in a variable way by at least one start condition for a respective recipe step. The preparation time can thus be shortened.

The preparation time can be shortened because the control unit can variably and thus flexibly adapt the sequence of recipe steps to the current situation based on a comparison of the start conditions with the current situation at the beginning of the food preparation or during the food preparation. If, for example, a user needs more time than average to cut onions, time can be saved by bringing forward another recipe step, e.g. to prepare a tomato paste for an onion pizza. The food processor can then chop and heat the tomatoes while the user finishes cutting the onions. In a traditional digital recipe of a domestic food processor, the sequence of steps is effectively imposed on the user and the tomato paste recipe step would be done later after the onions have been chopped. In addition, the preparation time can be shortened by defining start conditions of recipe steps instead of a rigid recipe step sequence, because an external food processing apparatus such as an oven, a mixer or a cooking pot on a stove can be better taken into account when setting the sequence of recipe steps by the control unit. Depending on which external food processing apparatuses are available, the control unit can bring the recipe steps into an optimized time sequence. Also a variable assignment of recipe steps to one of several available food processing apparatuses is enabled by a recipe defining at least one start condition for a respective recipe step instead of giving a rigid recipe step sequence.

In the following, exemplary implementations of the disclosed product are also explained in more detail using figures. Features of the examples can be combined individually or in a plurality with the claimed objects, unless otherwise indicated. The claimed scopes of protection are not limited to the exemplary implementations.

### BRIEF DESCRIPTIONS OF THE DRAWINGS

The figures show:

FIG. 1: Schematic representation or a food preparation using the invention;

FIG. 2: Schematic representation of a recipe according to the invention;

FIG. 3: Schematic representation of a method for setting a sequence of recipe steps according to the invention; and

FIG. 4: Schematic representation of a food preparation according to the prior art.

### DETAILED DESCRIPTION

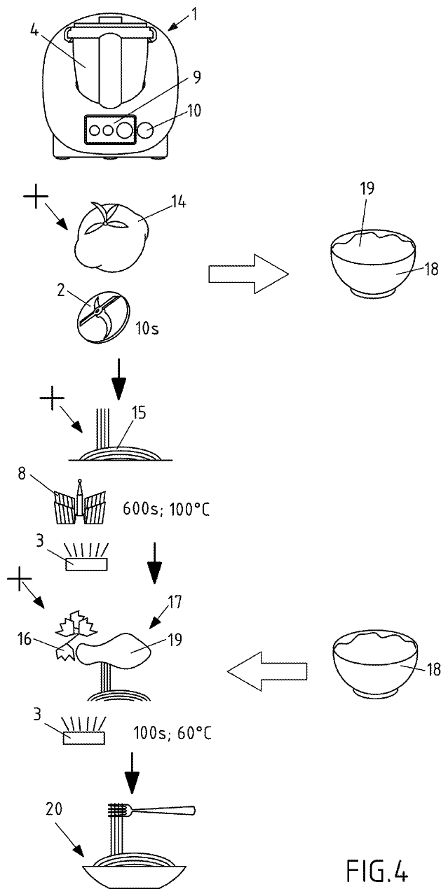

FIG. 4 illustrates a food preparation according to the prior art where a domestic food processor 1 performs a plurality of partially automated recipe steps according to a digital recipe file not shown. A touch screen display 9 and/or a rotary knob 10 form a user interface. The sequence of the recipe steps is fixedly and unchangeably predetermined by the recipe file. After the user has put a tomato 14 into pot 4 (represented by “+”) after a corresponding prompt, the tomato 14 is chopped by the rotating tool 2 and the user fills the intermediate product 19 into a bowl 18 for temporary storage. After cooking pasta 15 through heating by heating element 3 and stirring by means of the attachment 8 for the tool 2 in the pot 4, another ingredient 16 is added to the cooked pasta 15 together with the intermediate product 19 of the bowl 18 and the food mixture 17 is heated. The prepared food 20 can now be taken out of pot 4 and served.

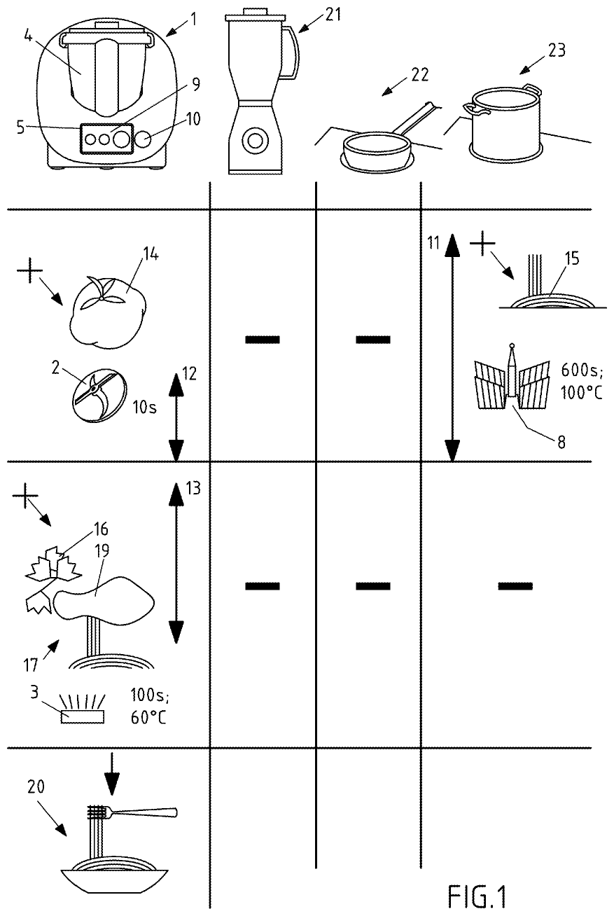

FIG. 1 illustrates the preparation of the same food 20 as in FIG. 4, but by using the presently disclosed system in a shorter preparation time. The time saved by parallelizing two recipe steps 11, 12 is just one example. In other examples, which are not discussed in detail here, time can be saved e.g. by specifically arranging the recipe steps or by changing the sequence of the recipe steps in response to a specific situation or a known characteristic of a user.

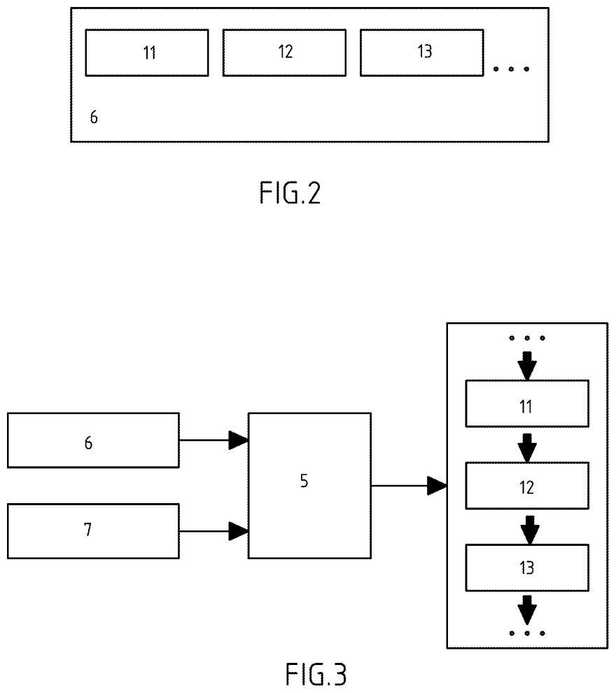

In the example shown, the domestic food processor 1 accesses a recipe 6 shown in FIG. 2. As schematically illustrated in FIG. 2, the recipe 6 comprises and defines a plurality of recipe steps 11, 12, 13, without prescribing a fixed sequence. The definition of the recipe steps 11, 12, 13 by the recipe 6 comprises at least one start condition for each of the recipe steps 11, 12, 13, so that the control unit 5 can set a sequence of the recipe steps 11, 12, 13 based on the start conditions of the recipe steps 11, 12, 13. The recipe 6 can be saved on a data carrier, a memory of the control unit 5, in a cloud memory or in an external database, wherein the domestic food processor 1 comprises a corresponding communication interface for accessing the recipe 6.

In this example, as illustrated in FIG. 3, an input variable 7 is evaluated by control unit 5 together with the start conditions of recipe steps 11, 12, 13 to set a sequence of recipe steps 11, 12, 13. In the example shown, the input variable 7 describes an availability of a plurality of external food processing apparatuses 21, 22, 23 shown in FIG. 1.

As shown in FIG. 1, the basically applicable food processing apparatuses are the domestic food processor 1 as well as an external mixer 21, an external pan 22 on a stove, and an external cooking pot 23 on a stove. Via a communication interface not shown—alternatively or additionally via user input by the user—the control unit 5 receives information about the availability of the external mixer 21, the external pan 22 on the stove and the external cooking pot 23 on the stove. This information about the availabilities is represented by the input variable. In particular, the stove transmits the information about the availability of the pan 22 and the cooking pot 23, preferably from at least one hotplate for a pan 22 and/or a cooking pot 23. Preferably, the availability of a pan 22 and a cooking pot 23 is taken for granted or confirmed separately by the user.

The control unit 5 of the domestic food processor 1 now evaluates the start conditions of recipe steps 11, 12, 13 from recipe 6 (FIG. 2) and the at least one input variable 7 (FIG. 3). In one configuration, in the start conditions of recipe steps 11, 12, 13, respectively, the required food processing processes (chopping, stirring, mixing, heating, steaming, roasting) are defined and/or the control unit 5 assigns food processing processes to the external food processing apparatuses and the (internal) functional components 2, 3 of domestic food processor 1. Alternatively or additionally, a start condition comprises a plurality of alternative choices of food processing apparatuses for the respective recipe step 11, 12, 13. In one embodiment, a display, preferably the touch screen display 9, is a functional component. In particular, the display or touch screen display 9 shows the user instructions for manually executing a step or sub-step of a recipe 6, e.g. adding an ingredient to pot 4. The addition can either be detected automatically, e.g. by using a non-displayed scale, or confirmed by the user, e.g. in particular by the user interface. The selection of one of a plurality of possible food processing apparatuses 1, 21, 22, 23 for the respective recipe step 11, 12, 13 can be stored by a parameter.

For example, in the example shown it is specified in the start conditions that recipe step 13 (heating a food mixture 17) is to be carried out both after completion of recipe step 11 (cooking pasta 15) and after completion of recipe step 12 (chopping tomato 14). In recipe step 13 the food mixture 17 is heated which consists of the cooked pasta 15 of recipe step 11, an intermediate product 19 of chopped tomatoes 14 of recipe step 12 and a further ingredient 16.

Furthermore it can be defined e.g. by recipe 6 in the start conditions of recipe steps 11 and 12 that these recipe steps 11 and 12 are executable in parallel. Furthermore, it can be defined e.g. by recipe 6 in the start conditions of recipe steps 11 and 12 that recipe step 12 can start with a time delay relative to recipe step 11 due to the shorter recipe step duration, especially so that both recipe steps end approximately simultaneously in case of a parallel arrangement. This gives the user the time to clean pot 4 of domestic food processor 1, for example, without increasing the total preparation time.

The control unit 5 has received information from the input variable 7 that the mixer 21 is not available and the pan 22 on the stove and the cooking pot 23 on the stove are available. As none of the recipe steps 11, 12, 13 can be executed with a pan 22 according to the start conditions, the pan 22 is already eliminated when determining the sequence of the recipe steps 11, 12, 13. The control unit 5 simulates a plurality of possible sequences of recipe steps 11, 12, 13, where fulfillment of the start conditions can be ensured. In particular, prioritization information of the individual recipe steps 11, 12, 13 is taken into account, according to which e.g. the domestic food processor 1 has to be used with a higher prioritization compared e.g. with the cooking pot 23 on the stove for the recipe step 13.

At the end of the evaluation the control unit 5 sets the sequence with the shortest preparation time which ensures that all start conditions are fulfilled.

The result is shown in FIG. 1. With “-” a food processing apparatus is marked which is not intended for the recipe step 11, 12, 13 in question by control unit 5 according to the set sequence with the above mentioned parameters (for setting the assignment of a recipe step 11, 12, 13 to a food processing apparatus 1, 21, 22, 23). For simplicity, in the example shown in FIG. 1, not all individual recipe steps have been described separately as such, such as e.g. adding the corresponding ingredients to pot 4. Adding an ingredient can also be a separate recipe step and as such can be defined in recipe 6 by means of at least one start condition.

Typically, e.g. a heating element and/or a rotating tool for chopping or mixing are among the functional components of a domestic food processor for preparing a food.

Recipe means a digital recipe. A digital recipe is a data record that defines several recipe steps. The definition of the recipe steps includes at least one start condition. In addition, control commands for one or more electrically operable functional components of the domestic food processor are assigned to each recipe step. Optionally, the definition of the recipe can additionally comprise algorithms that allow the control unit to determine whether a start condition is fulfilled depending on at least one input variable. In particular, the definition can contain a prioritization information and/or a prioritization algorithm. Preferably, the definition can include an assignment to a recipe step module with several recipe steps.

The start condition of a recipe step means that the respective recipe step is only executed when the start condition is fulfilled. In one configuration, a recipe step comprises at least two start conditions. In one configuration a fulfillment of a start condition can be checked or monitored by the control unit during food preparation. In a particularly preferred alternative or supplementary configuration, a start condition can be used by the control unit to bring the recipe steps at the beginning of the food preparation into a sequence which ensures that the respective start conditions of the individual recipe steps are fulfilled, preferably with a time-optimized sequence. In particular, this sequence, which is set at the beginning of the food preparation, is variable and can be changed during the food preparation. Alternatively, a setting of a later unchangeable sequence is basically possible.

In one embodiment the control unit is configured such that the control unit sets a sequence of the recipe steps on the basis of the start conditions of the recipe steps and at least one input variable. The preparation time can thus be shortened.

In one embodiment the control unit is configured such that the control unit can set or change the sequence of the recipe steps during food preparation. By a flexible adaptation to the current situation the preparation time can thus be reduced.

In one embodiment the control unit is configured such that the control unit can determine on the basis of the input variable whether a start condition of a recipe step is fulfilled, for example by comparing the input variable with a start condition. For example, a start condition can be the reaching of a predefined temperature of the food in the pot, which is or was heated due to another, earlier recipe step. The temperature can then be the input variable, so that the relevant recipe step is started when the control unit determines from the temperature that the start condition is fulfilled. In one configuration the input variable is an information that is dependent on a sensor signal. Preferably the sensor signal comes from a sensor of the domestic kitchen appliance (domestic food processor). In an alternative or supplementary configuration, the input variable can be a user confirmation for the completion of a particularly manual recipe step or an automatically generated status information about the completion of a current recipe step. In one configuration a start condition can be a completion of a specific recipe step or several specific recipe steps. Preferably the completion of a recipe step is automatically recognized by the control unit when the duration of the recipe step has expired.

In one embodiment the control unit is configured such that the control unit can set the sequence of recipe steps at the beginning of a food preparation. The entire sequence of recipe steps can then be set at the beginning of a food preparation. The sequence for all recipe steps can then be set at the beginning of a food preparation. Optionally, a change of the sequence that has been set at the beginning of a food preparation is possible. “At the beginning of a food preparation” means the time after the user has selected a recipe and/or before the first recipe step is activated or is displayed to the user for activation.

For setting the sequence of the recipe steps at the beginning of a food preparation the control unit evaluates the start conditions of the recipe steps, especially together with the at least one input variable. Preferably the control unit only considers those start conditions of the recipe steps of which the respective fulfillment can be determined depending on a sequence of the recipe steps. In a preferred configuration all start conditions for the determination of the sequence are considered at the beginning of a food preparation, wherein assumptions for input variables are taken as a basis, which can only be determined or transmitted during the food preparation. These assumptions can preferably be provided by the recipe.

The control unit comprises an algorithm for generating a sequence of recipe steps based on the start conditions and optionally input variables. Alternatively, the recipe can provide the control unit with a sequence generation algorithm so that the control unit can set a sequence of recipe steps based on the start conditions and optionally on input variables.

In one embodiment the input variable describes an availability of an external food processing apparatus. The preparation time can thus be reduced. In particular, the external food processing apparatus is a mixer, a cooking pot on a stove, a pan on a stove and/or an oven.

Preferably, the input variable of the availability of an external food processing apparatus is obtained from the control unit and/or evaluated together with the start conditions of the recipe steps at the beginning of a food preparation in order to set the sequence of the recipe steps especially at the beginning of a food preparation. In one configuration, a start condition of a recipe step comprises a plurality of alternative choices with respect to the food processing apparatus which can execute the recipe step. In particular, the domestic food processor is such a choice with respect to the food processing apparatus for recipe steps, in which a food is chopped, mixed, fried or heated. By taking into account the temporal capacity of the food processing apparatuses available for a recipe step, i.e. the domestic food processor itself and external food processing apparatuses, a temporally optimized sequence of the recipe steps can be obtained.

In one configuration the control unit simulates a variety of possible sequences, where the fulfillment of all start conditions of all recipe steps can be guaranteed, and sets the sequence with the shortest food preparation time at the beginning of the food preparation. In particular, a random generator is used to generate the variety of possible sequences, in which all start conditions of all recipe steps are fulfilled. For recipes where the individual recipe steps do not build on each other very much, a large part of recipe steps of equal rank may be present, i.e. several recipe steps are interchangeable in a sequence (if all start conditions are fulfilled).

In one configuration the input variable of the availability of an external food processing apparatus is obtained during food preparation. For example, if the oven is in parallel other use during food preparation under the guidance of the domestic food processor and a baking time programmed on the oven has not yet elapsed, the domestic food processor may bring forward another recipe step and change the sequence of recipe steps accordingly during food preparation. The same applies if the oven suddenly and unexpectedly becomes defective and is no longer available. In another example, if a cooking pot is available on a stove, the control unit can set during food preparation that a next step for cooking e.g. pasta in the cooking pot should take place, so that the pasta sauce is completed by the domestic food processor.

In one embodiment, the recipe is configured such that a start condition can comprise a plurality of alternative choices, for example a plurality of usable food processing apparatuses or a plurality of operating settings for a functional component such as desired rotation numbers or desired temperatures. A time optimized sequence of the recipe steps can be thus achieved, as described below.

In one embodiment the control unit is configured so that the control unit saves (stores) a selection made for fulfilling a start condition as a parameter for performing the recipe step. In this way the control unit can, for example, in the context of a simulation of a variety of possible sequences for the recipe steps, respectively base a different selection for the individual start conditions and take this selection into account in the subsequent steps by saving it in the parameter. A time optimized sequence of the recipe steps can thus be achieved.

In one embodiment the control unit is configured such that, based on the input variable, the parameter for a recipe step is set and saved. A time optimized sequence of the recipe steps can thus be achieved.

In one configuration, for setting and saving the parameter during food preparation, a parameter of a recipe step can contain a desired temperature, a desired rotation number or a desired processing time. For example, if the user selects a lower desired temperature than the recipe originally intended for the recipe step, this desired temperature of the user is used and time is saved. If the user selects a higher desired temperature, in one configuration the user can either be shown a warning or the desired temperature originally intended by the recipe can be used to save time. Preferably, algorithms that describe the relationship between an input variable and a parameter are provided by the recipe so that the control unit can set the parameter accordingly.

In one embodiment the recipe is configured such that a food processing apparatus is saved by said parameter for the respective recipe step selected from a plurality of food processing apparatuses suitable for fulfilling a start condition. In other words, it is determined by the parameter whether a recipe step assigned to this parameter is to be executed by the domestic food processor or by an external food processing apparatus. The preparation time can be reduced in total in this way.

In one embodiment the recipe steps are defined by the recipe such that two recipe steps can be executed in parallel in time. For example, a recipe step with a chopping of an ingredient can be performed by an external mixer, while the food is steamed in the domestic food processor for a longer period of time before the chopped ingredient is added to the food.

In one embodiment, the control unit is configured such that for executing a recipe step the control unit transmits control commands of the recipe step to at least one functional component of the domestic food processor and transmits other control commands of a recipe step to be executed in parallel in time to an external food processing apparatus. The preparation time can thus be reduced in total.

In one configuration the control unit comprises a communication interface for receiving and/or transmitting data to an external food processing apparatus. In particular, the data includes an input variable and/or control commands. Preferably, the transmission is wireless, e.g. via a Bluetooth communication interface or a Wi-Fi communication interface. In particular, the input variable is transmitted by a food processing apparatus. In one configuration a plurality of food processing apparatuses can transmit one input variable each to the control unit. In one configuration the controller (control unit) can transmit control commands to one or a plurality of external food processing apparatuses. An independent aspect of the disclosed system relates in this context to a system comprising the domestic food processor and one or a plurality of external food processing apparatuses, all of which have a communication interface.

In one embodiment the recipe is configured such that two recipe steps which are executable in parallel in time can be furnished with a start condition which provides for a time-delayed start of one recipe step relative to the other recipe step, a simultaneous start or a simultaneous completion of the recipe steps. Thus, a shortest possible preparation time is enabled. A simultaneous completion of two recipe steps executable in parallel can be achieved, for example, by subtracting the recipe step duration of the shorter recipe step from the recipe step duration of the longer recipe step and using this difference as delay time. After the start of one recipe step, the other recipe step is started after the delay time has expired and thus its start condition (in this respect) is fulfilled.

In one embodiment the recipe is configured such that a prioritization information or a prioritization algorithm is assigned by the recipe to a recipe step or alternative choices of a start condition. In this way, time-optimized processes can be better incorporated into the setting of the sequence.

A prioritization information can be e.g. a prioritization value, so that a recipe step with a high prioritization value will be arranged in the sequence of the recipe steps if possible temporally before a recipe step with a low prioritization value or will be started earlier at a parallel arrangement of recipe steps. A prioritization algorithm can perform the prioritization of a plurality of equally important recipe steps or alternative choices. For example, a prioritization algorithm can prescribe that in the case of equally important recipe steps, those recipe steps with a shorter duration should be arranged with priority in the sequence.

In one configuration, the domestic food processor always has a higher prioritization in the form of a prioritization information or in a prioritization algorithm, if a plurality of—in particular otherwise equally important—food processing apparatuses are available as alternative choices of a start condition. This enables the domestic food processor, which is generally already optimized for a short preparation time, to be used with priority. The preparation time can be further reduced in this way.

In one embodiment the recipe is configured in such a way that a plurality of recipe steps are combined into a module. A time-optimized sequence of recipe steps can thus be set particularly efficiently. In particular, a module is arranged as a whole in a sequence. For example, a temporal sequence for two recipe steps of the module, which should follow each other directly, can be fixed by the recipe. It is also possible in one configuration, that a fixed arrangement of all recipe steps of the module to each other, especially temporally in parallel and/or successively, is given by the recipe.

In one configuration the recipe is configured such that the start condition of a recipe step is independent from another recipe step or dependent on another recipe step. In particular, the recipe is configured such that in a start condition a link or dependency is set with respect to the start or completion of a particular other recipe step or a plurality of other particular recipe steps. In one configuration, a start condition is provided that prescribes an immediately preceding recipe step.

The following three further aspects of the present disclosure can be combined with the above mentioned features of the description and also serve to shorten a time of food preparation.

A first further aspect of the present disclosure relates to a method for controlling a domestic food processor with a plurality of electrically operable functional components for preparing a food in a pot, comprising the steps: Accessing, by a control unit of the domestic food processor, a recipe with a plurality of recipe steps by which an operation of one of the functional components can be controlled; and Setting, by a control unit, at least one next recipe step at the latest at the end of a preceding recipe step depending on start conditions defined by the recipe for each of a plurality of recipe steps.

A second further aspect of the inv present disclosure ention relates to a computer program product, comprising instructions which, when a program of the computer program product is executed by a computer, in particular the control unit, cause the computer to carry out the steps of the method according to the first further aspect of the invention.

A third further aspect of the present disclosure relates to a computer program product comprising a digital recipe having a plurality of recipe steps for controlling electrically operable functional components of a domestic food processor for preparing a food in a pot of the domestic food processor, wherein the recipe is configured such that the recipe defines at least one start condition for each of a plurality of recipe steps, so that a control unit can set a sequence of the recipe steps depending on the start conditions of the recipe steps.

1. A domestic food processor comprising
a plurality of electrically operable functional components for preparing a food in a pot, and
a control unit configured to access a recipe and to operate one of the functional components in a manner defined by a recipe step included in the recipe,
wherein the recipe defines at least one start condition for each of a plurality of recipe steps, and the control unit is configured such that, depending on the start conditions of the recipe steps, the control unit can set at least one next recipe step at the latest at the end of a preceding recipe step.

2. The domestic food processor of claim 1, wherein the control unit is configured such that the control unit sets a sequence of the recipe steps on the basis of the start conditions of the recipe steps and at least one input variable.

3. The domestic food processor of claim 2, wherein the control unit is configured such that the control unit either sets or changes the sequence of the recipe steps during food preparation.

4. The domestic food processor of claim 1, wherein the control unit is configured such that the control unit sets the sequence of recipe steps at the beginning of a food preparation.

5. The domestic food processor of claim 2, wherein the input variable describes an availability of an external food processing apparatus.

6. The domestic food processor of claim 2, wherein the recipe is configured such that a start condition comprises a plurality of alternative choices, and the control unit is configured such that the control unit saves a selection made for fulfilling a start condition as a parameter for performing the recipe step.

7. The domestic food processor of claim 6, wherein the recipe is configured such that a food processing apparatus is saved by said parameter for the respective recipe step selected from a plurality of food processing apparatuses suitable for fulfilling a start condition.

8. The domestic food processor of claim 1, wherein the recipe steps are defined by the recipe such that two recipe steps can be executed in parallel in time.

9. The domestic food processor of claim 8, wherein the control unit is configured such that for executing a recipe step the control unit transmits control commands of the recipe step to at least one functional component of the domestic food processor and transmits other control commands of a recipe step to be executed in parallel in time to an external food processing apparatus.

10. The domestic food processor of claim 8, wherein the recipe is configured such that two recipe steps which are executable in parallel in time can be furnished with a start condition which provides for a time-delayed start of one recipe step relative to the other recipe step, a simultaneous start or a simultaneous completion of the recipe steps.

11. The domestic food processor of claim 1, wherein the recipe is configured such that a prioritization information or a prioritization algorithm is assigned by the recipe to a recipe step or alternative choices of a start condition.

12. The domestic food processor of claim 1, wherein the recipe is configured such that a plurality of recipe steps are combined into a module.

13. The domestic food processor of claim 2, wherein the control unit is configured such that the control unit sets the sequence of recipe steps at the beginning of a food preparation.

14. The domestic food processor of claim 3, wherein the control unit is configured such that the control unit sets the sequence of recipe steps at the beginning of a food preparation.

15. The domestic food processor of claim 3, wherein the input variable describes an availability of an external food processing apparatus

16. The domestic food processor of claim 2, wherein the control unit is configured to determine on the basis of the input variable whether a start condition of a recipe step is fulfilled.

17. The domestic food processor of claim 9, wherein the recipe is configured such that two recipe steps which are executable in parallel in time can be furnished with a start condition which provides for a time-delayed start of one recipe step relative to the other recipe step, a simultaneous start or a simultaneous completion of the recipe steps

18. A method for controlling a domestic food processor with a plurality of electrically operable functional components for preparing a food in a pot, the method comprising the steps:
accessing, by a control unit of the domestic food processor, a recipe with a plurality of recipe steps by which an operation of one of the functional components can be controlled,
setting, by a control unit, at least one next recipe step at the latest at the end of a preceding recipe step depending on start conditions defined by the recipe for each of a plurality of recipe steps.

19. A computer readable medium product comprising instructions which, when a program of the computer program product is executed by a computer, cause the computer to carry out the steps of
accessing, by a control unit of a domestic food processor, a recipe with a plurality of recipe steps by which an operation of one of the functional components can be controlled, and
setting, by the control unit, at least one next recipe step at the latest at the end of a preceding recipe step depending on start conditions defined by the recipe for each of a plurality of recipe steps.

20. A computer readable medium product comprising a digital recipe having a plurality of recipe steps for controlling electrically operable functional components of a domestic food processor for preparing a food in a pot of the domestic food processor, wherein the recipe is configured such that the recipe defines at least one start condition for each of a plurality of recipe steps, so that a control unit can set a sequence of the recipe steps depending on the start conditions of the recipe steps.
